(19) United States
(12) Patent Application Publication
(10) Pub. No.: US 2002/0165822 A1
(43) Pub. Date: Nov. 7, 2002

(54) Method of billing services, server and telecommunication systems

(76) Inventor: Risto Makipaa, Fiihimaki (FI)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 09/980,195

(22) PCT Filed: Apr. 6, 2001
(86) PCT No.: PCT/FI01/00339

(30) Foreign Application Priority Data
Apr. 7, 2000 (FI) 20000838

(51) Int. Cl. G06F 17/60

(52) U.S. Cl. 705/40; 705/39

(57) ABSTRACT

A service provider's server (SPS) receives dynamically address data and service attributes of available billing services and servers on telecommunication networks, such as the Internet, in advertising messages (DAAvert) which billing servers (BS1, BS2, BS3) or special directory servers (DA) send. The service provider's server (SPS) can select one billing service from among the available billing servers for the billing transaction of a client on the basis of the parameters given by the client and said service attributes or offer advertised billing services for the client to select. Then the service provider's server initiates the billing transaction with the billing server of the selected billing service by means of said address data and service attributes or transfers billing to the selected billing server which performs it. In an embodiment of the invention the server (SPS) is configured to transfer the billing transaction to the billing server and the client, which perform it using the attributes supported by the billing server and receive an acknowledgement of billing carried out from the billing server. The server preferably creates an invoice form which is transferred to the client device in a pre-filled form for use in a billing transaction between the client device and the billing server.

The invention relates to billing of services in a telecommunication systems which comprise servers of service providers and billing servers, which provide billing services.

Electronic commerce (e-commerce) is a fast growing field of trade, which generally refers to all business by means of computers to sell products and services, particularly on the Internet. At its simplest opening of a commerce site on the Internet means opening of a WWW (World Wide Web) site on a server connected to the Internet. The minimum features the sales software of a service provider must have on the server include means for creating a product catalogue, for management of a shopping basket and for receiving orders. Other important features may include customer management, personification, auxiliary purchasing tools and handling of payment transactions. Furthermore, means or external interfaces are usually needed to implement billing, warehouse management, logistics and reporting. Nowadays software packets are available which contain all the programs needed to create WWW services, including the Web server, browser, content management and program development tools. Examples of such software packets are Microsoft Site Server Commerce and IBM Net.Commerce. By means of these one can create an appropriate client interface for displaying and browsing product catalogues and for performing ordering and payment transactions. One can open an e-commerce site using these software tools, or create the whole software oneself. However, also when software tools are used, opening of a commerce site requires at least creation of a product catalogue and customization of the application. Establishment of a commerce site resembles the development project of a conventional WWW application.

On the Internet there are several methods of payment available for electronic commerce. In Finland the most common methods of payment are cash on delivery, invoicing and on-line bank giro by means of a WWW form. Out of Finnish banks Leonia, Merita (Solo service) and Osuuspankki (Kultaraha service) provide interfaces to their bank giro services. Credit card payments can be received via a credit card company. For example, payments by both Visa and Eurocard/Mastercard can be received and transmitted to the credit card company (Luottokunta in Finland) by means of SET (Secure Electronic Transaction) software intended for retailers, or over an ssl (secure sockets layer) secured connection, in encrypted e-mail, by telephone, fax or mail.

Regardless of the various alternatives, the problems related to payment of products and services are the most important factors that slow down the spread of chargeable services into the Internet environment. First of all, the data security of the e-commerce system requires considerably more attention than a conventional web service. In e-commerce chargeable services have typically been billed by transmitting the necessary credit card data to the service provider who debits the price of the services submitted from the user's credit card. The users' mistrust and unwillingness to give credit card data to a service provider they may not even know limits the use of such services. In other methods of payment, on the other hand, the service provider wants to ensure that he will really receive the payment from the client before supplying a service or delivering a product. This has resulted in complicated systems in which the data security and the interests of both the service provider and the client are ensured. Both parties must have agreements at least with banks or other bodies which support this system. Furthermore, the service provider's server software has to support the payment protocol in question. However, such heavy payment systems are not necessarily suitable for selling services or goods whose unit prices or sales volumes are low. Such a service could be e.g. selling of self-produced magazines, books, pictures or other similar material as electronic files over the Internet. In that case the agreements and software required by secure payment methods and any payment transaction specific fees or minimum invoice amounts may prove too laborious or expensive for a person who plans to open an e-commerce site, and thus prevent this. A further problem arises from the fact that a commerce site should preferably support as many of the methods of payment the clients want to use as possible.

The object of the invention is to enable simple and flexible billing at the server of a service provider in electronic commerce.

This is achieved with methods according to claims 1 and 22, a telecommunication system according to claim 12 and a server according to claims 17 and 26. The preferred embodiments of the invention are described in the dependent claims.

The basic idea of the invention is that the service provider's server receives dynamically address data and service attributes of billing services and servers available in data transmission networks, such as the Internet, in advertising messages transmitted by billing servers and special directory servers. The service provider's server can select one billing service from among available billing servers for the billing transaction of a client according to the parameters given by the client and the above-mentioned service parameters, or offer the advertised services for the client to select. Then the service provider's server initiates the billing transaction with the billing server of the selected billing service by means of the above-mentioned address data and service attributes or transfers billing to the selected billing server, which performs it. Thanks to the invention, the software of the server can be general software, which according to a pre-agreed protocol can, after opening of the service, track and start using different methods of payment available on the network and offer these to the clients. The rest of the network supports this functionality by providing information on billing services according to the agreed protocol. Furthermore, the server can update the data at suitable intervals, when necessary or always when the client places an order. The reason for sending a service request could be e.g. that the method of payment requested by the client is unfamiliar to the server. The service attributes may indicate which billing services require an agreement between the billing server and the service provider and which services do not. In that case the server or the service provider can, if desired, choose billing servers which do not require an agreement and/or make an agreement with suitable billing servers. The invention enables outsourcing of billing transactions from the service provider to separate billing servers.

The server preferably comprises at least general functions which are independent of billing and payment protocols and allow tracking and selection of a suitable billing server and handshaking with the selected billing server. A billing transaction is typically performed according to the digital payment or billing protocol supported by the selected billing server. In the first embodiment of the invention the billing server performs the billing transaction. The server preferably configures with the payment or billing protocol supported by the billing server on the basis of the above-mentioned service attributes received in the advertising message and/or the data, file or software received from the billing server after handshaking. At least after configuration the server software can function as a party in a payment or billing procedure supported by the billing server. In an embodiment of the invention the server is configured to transfer the billing transaction to the billing server and the client utilizing the attributes supported by the billing server and to receive an acknowledgement of the billing carried out from the billing server. The server preferably creates an invoice form which is transferred to the client device in a pre-filled form so that it can be used in a billing transaction between the client device and the billing server.

According to an embodiment of the invention, the billing server controls the payment or billing transaction after the first handshaking, which means that only the client and the service provider's server are parties to the transaction. The billing server is preferably also responsible for verification of the client and possibly for that of the service provider, too, and makes payment to the service provider. In other words, billing is outsourced to the service provider. An advantage of this is that each payment protocol requires fewer special functions and smaller software at the service provider's server. Furthermore, the service provider does not need to worry about the client's honesty or ensure solvency. The client, on the other hand, knows that during the payment transaction he is dealing with a familiar party, which he may even have chosen himself.

In an embodiment of the invention the billing server collects service payments made by the client to different service providers and bills the client for them in a combined invoice at suitable intervals. The billing server may be a billing server owned e.g. by a telecommunication operator, a service operator or a similar body with which the client has a service agreement, or it may be connected to such a server. In that case the service payments collected for the client can be billed in connection with a normal service invoice of such a body, e.g. in a phone bill. This may be a cheaper alternative both for the client and the service provider than e.g. electronic bank transfer, particularly when the invoiced value is small. A telecommunication operator may also find this kind of billing service attractive because the growth of business increases traffic on the network and thus telecommunication payments.

On the whole, the present invention allows very easy and flexible billing when an e-commerce site is opened.

In the following, the invention will be described by means of preferred embodiments with reference to the accompanying drawings, in which

FIG. 1 illustrates an embodiment of the invention in the Internet/Intranet environment,

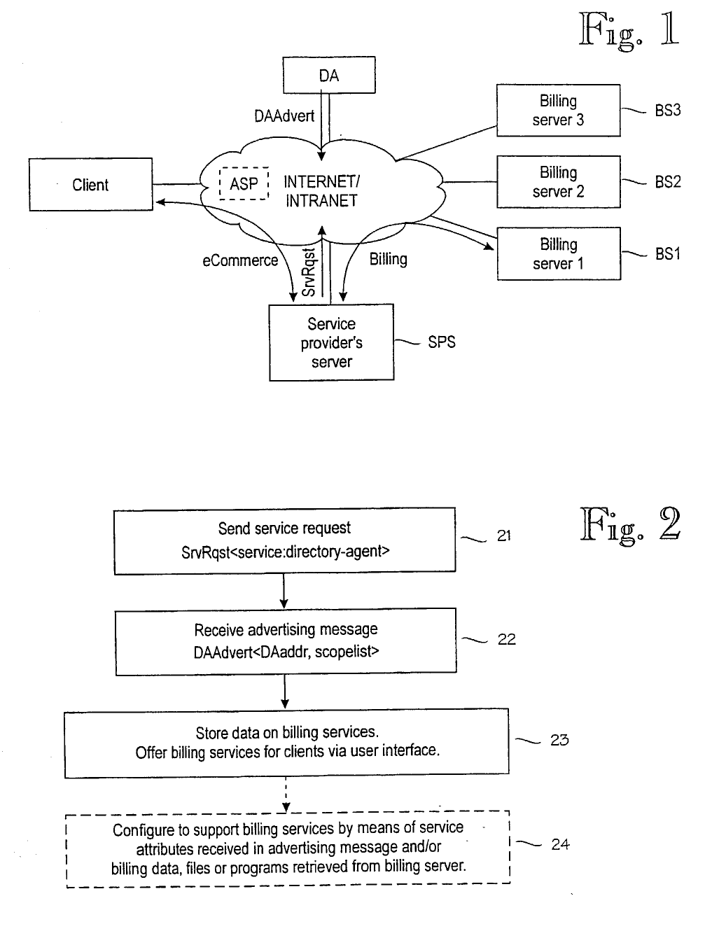

FIG. 2 is a flow chart illustrating initialisation of a service provider's server according to an embodiment of the invention, and

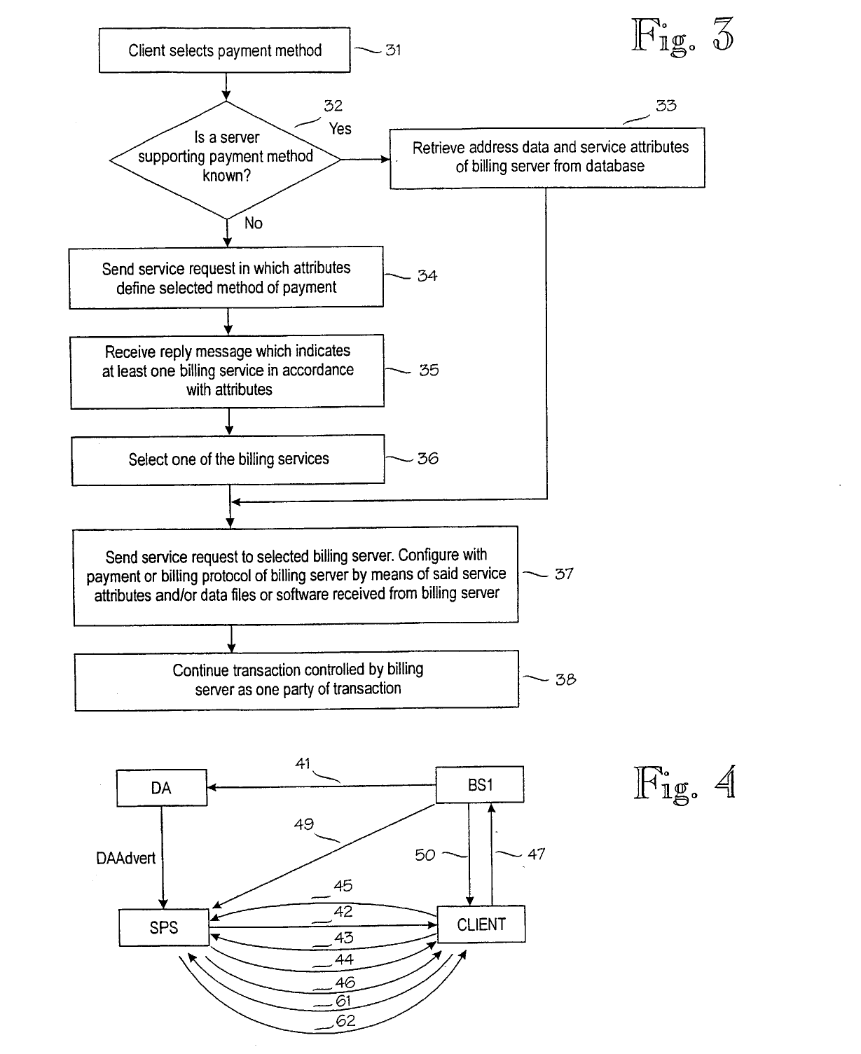

FIG. 3 is a flow chart illustrating function of the service provider's server when it tracks and selects a billing server and establishes a connection to it during an electronic business transaction,

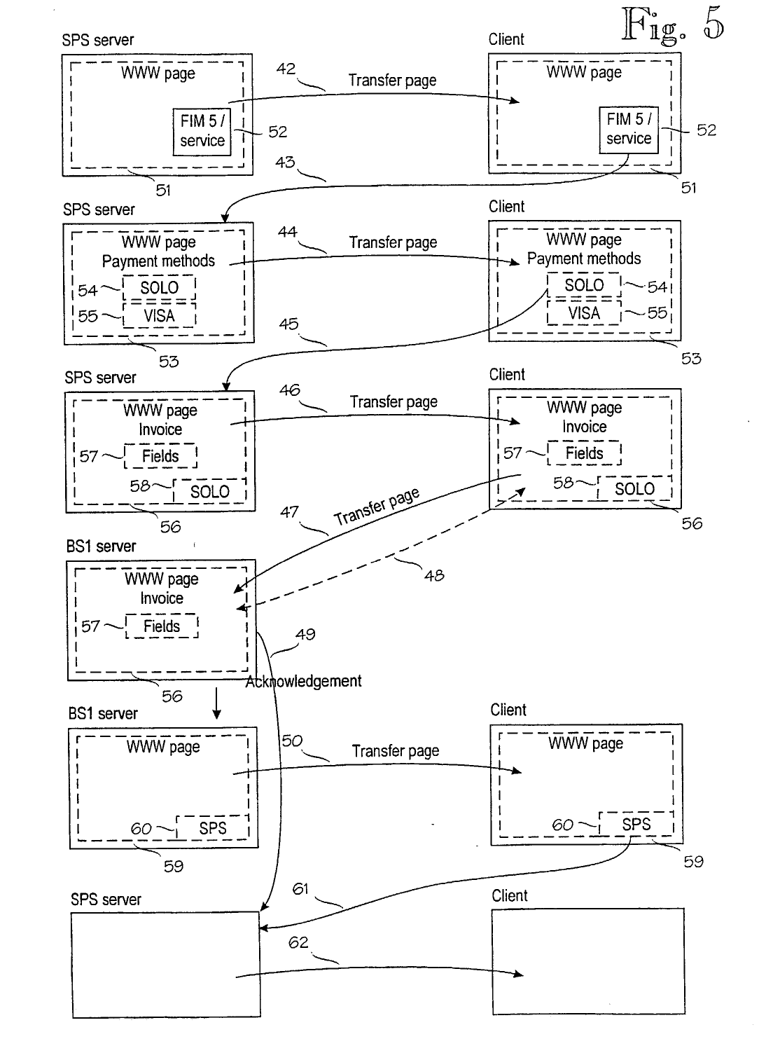

FIGS. 4 and 5 are block diagrams and signalling charts illustrating another embodiment of the invention.

The present invention is suitable for all telecommunication systems where a client device, typically a terminal of a telecommunication network, can communicate, typically through a TCP/IP protocol stack (Transport Control Protocol/Internet Protocol), with a server connected to the same or to another network. The server may be e.g. a server which generally provides services on the Internet and the client a terminal in a wired or wireless telecommunication network.

The Internet is simply a network of networks which supports TCP/IP based applications, such as the World Wide Web (WWW), SMTP (Simple Message Transport Protocol), Email or FTP (File Transfer Protocol). Parts of the Internet are called subnetworks, which are connected to one another by gateways or routers. The word ‘host’ is used for computers which are connected to the network. Often one of the hosts is a ‘client’ and the other one a server. A computer which requests or receives services from another computer in the network is called a client. The server is a computer which offers services for other computers in the network.

FIG. 1 illustrates the present invention in the Internet/Intranet environment. The service provider's server SPS is connected to the Internet to establish a commerce site for electronic commerce where clients can buy services or products. In this example the products are files (e.g. voice, image, text or multimedia files) or programs which can be transferred over the Internet from the server SPS to the client during a business transaction. The interface offered by the commerce site and other implementation are not relevant to the invention, except for billing, and will not be described in greater detail here. The software solutions can be based on the above mentioned commercial programs intended for electronic commerce, i.e. IBM Net. Commerce and Microsoft Site Server Commerce, for instance. In that case the software usually comprises at least means for creating a product catalogue, for shopping basket management and for receiving orders.

Instead of the above-mentioned commerce site programs, the commerce site can also be implemented in a simpler manner by establishing links on normal WWW pages to chargeable and downloadable files or stream-type services (e.g. real time video). These files can be downloaded or the services initiated after payment has been made according to the principles of the invention. According to the preferred embodiments of the invention, the server can in that case transfer billing to a separate billing server, which carries it out, and wait for confirmation of the billing performed. According to the invention, this is feasible because the server can outsource the billing transaction by means of general software which is configured according to the service attributes as will be described below.

The client interface is typically based on a WWW site which the client can browse like other WWW sites using a commercial browser program included in the client device. The client device can be any computer or terminal connected to the Internet directly, or, as is typical of private clients, through specific Internet operators or Internet access providers' (ASP) dial-up servers or gateways, with which the client can establish a modem or an ISDN connection over the normal telephone network. The terminals of other networks, such as mobile communication networks, can communicate via special gateway servers. In that case a mobile station may use the short message service (SMS) or the WAP service (Wireless Application Protocol), for example. As was stated above, the client's interface as well as the access method by which the client can use the services of the SPS server are not relevant to the present invention.

The general object of the invention is to facilitate establishment of an electronic commerce site by providing an easy and flexible solution for billing.

A further object of the invention is to provide outsourcing of billing of chargeable services, such as electronic contents, added to the WWW server and allow electronic payment for delivery of bulk goods of various kind reliably without the server needing software means and agreements with banks, for example, for carrying out billing.

In the preferred embodiment of the invention, the billing software of the SPS server is general software, which according to a pre-agreed protocol tracks different payment methods/billing servers available on the network, offers these to its clients and outsources billing to the billing server selected by the client according to the pre-agreed protocol. Billing servers and agents supporting this functionality are connected to the Internet network by giving information on billing services according to this agreed protocol. In the preferred embodiment of the invention this agreed protocol is based on the SLP protocol (Service Location Protocol) standardized for the Internet. This protocol has been defined in request for comment RFC 2165 of the Internet Engineering Taskforce (IETF). The SLP protocol has been designed for tracking different network resources (printers, servers, fax machines) and for simplifying their use particularly in company networks and in the Intranet. However, the same principles also apply to the present invention. The SLP is a client/server-based service transmission process which is based on the agent technology known per se and which enables dynamic binding of the services desired by the user to the network address that transmits the service. In the basic architecture of the SLP the user makes a service request from an application in his terminal to a user agent on the network, the user agent being a program procedure which functions independently of the network on behalf of the user and tracks a service according to the attributes defined by the user in the network. The servers in the network display the service data of the services they offer, such as address and configuration data. Directory agents collect the service data provided by the servers into one location and thus the directory agents have information on all the services available. In the first preferred embodiment of the invention shown in FIG. 1 the service provider's server SPS functions in place of the user agent of the conventional SLP protocol and retrieves services for itself, not for the actual user. According to the principles of the SLP protocol, a number of billing servers BS1, BS2 and BS2 and at least one directory agent DA have been connected to the network. The billing servers BS1, BS2 and BS3 provide different methods of billing and payment for electric commerce. These can be payment services of banks, such as Solo service of Merita Nordbanken, Kultakortti payment service of Leonia bank or a service of a credit card company (e.g. Visa, Mastercard). The billing server BS can also be a kind of proxy server which provides the SPS server with an opportunity of using payment services in which one or more other billing servers are involved. An example of this will be described below. The billing server BS can also be a billing service of another service provider which makes payment to the SPS server on behalf of the client and bills the client later when it bills the client for its own services. In principle, the implementations of the billing servers and the payment and billing protocols used by them are irrelevant to the basic functions of the present invention. The billing servers BS1 to BS3 present service data of the services provided by them, such as address and configuration data of the services. The billing servers BS1 to BS3 register the service data of the billing services they include with the directory agent DA, which acknowledges the data it has received. The servers BS1 to BS3 must register and update their service data at regular intervals, otherwise the service data are deleted from the directories of the directory agent DA. The billing servers BS1 to BS3 also inform the directory agent DA of services which have been removed, in which case the directory agent deletes the service data of these services from its directories. Thus the directory agents always have updated information on the billing services available.

The service data naturally include the URL address of the service. In addition, the service data preferably comprise different service attributes, which determine the type of the billing service in greater detail. In that case the attributes could indicate the name of the service provider, e.g. the name of the bank, such as Osuuspankki, Merita, Leonia, Deutsche Bank, or the name of the credit card, such as Visa or Mastercard. The attributes can also define the digital payment system on which the service is based; in that case the attributes could be the following: SSL (Secure Sockets Layer), SET (Secure Electronic Transaction), First Virtual, Cipher Cash, Digi Cash, and Millicent (the four last mentioned are prior art digital payment systems). The attributes can also include information on whether the SPS server needs to make an agreement in advance with the provider of the billing service or not, and/or on any billing fee charged by the billing server, e.g. 2% of the total price. The attributes may also contain configuration parameters for configuring the SPS server to communicate with the billing server and attributes needed to outsource billing. The last-mentioned attributes can be used for specifying the type and structure of the file, such as an invoice form, used for outsourcing billing.

In the SLP protocol services are defined in greater detail using service type templates. An SPL template could have e.g. the following form: Service:billing:http://alma-serv/billing;protocol:SET. This template defines that the billing service can be found in format at the URL address alma-serv/billing. For the sake of clarity, the example includes only one service attribute which defines SET as the protocol. More attributes can be linked one after another to provide all the desired data.

The service provider's server SPS can configure with different billing services when it is connected to the network or as clients ask for different methods of billing or payment. The preferred embodiment of the invention applies both these principles. First we will describe initialisation of the service provider's service SPS with reference to FIGS. 1 and 2 when an e-commerce site is opened. In that case the server has only general software for billing, which utilizing the SLP protocol tracks and starts to use different payment methods available on the network and offers these to the clients.

In step 21 of FIG. 21 the SPS sends a service request in accordance with the SLP protocol, the service request having e.g. the form Srvrqst<service:directory-agent>. The request is transmitted as multicast or broadcast to the Internet. Since ‘directory-agent’ has been defined as the service type, only directory agents DA react to it. They respond to this service request by sending a DA advertising message DAAdvert, as has been defined in the SLP protocol. The DAAvert message contains the address DAAddr of the directory agent and a scope list of the services offered by the directory agent. In step 22 of FIG. 22 the SPS server receives a DAAdvert message. Then the SPS server selects the data of the billing services from the list and stores them in its database. The SPS also modifies the WWW pages of the commerce site by means of the data it has received so that available billing services are offered to the client via a user interface (step 23). In addition, the SPS can be already in this step configured to support billing services by means of the service attributes received in the advertising message. Here configuring also refers to combining the payment required of a chargeable service by the service provider with the corresponding service attributes for transferring billing data when billing is outsourced, and to introduction of protocols needed to encrypt the traffic between the parties to a billing transaction. The SPS server can also contact the billing servers and download data, files or software therefrom, by means of which the server can communicate with the billing servers and support their payment and billing protocols (step 24). This configuration during initialisation is, however, an optional feature and can also be implemented so that it is carried out each time the SPS server initiates outsourcing of billing.

Transmission of the service request (step 21 in FIG. 2) is not necessary in the initialisation step, either. The directory agents regularly send DAAdvert messages to the network, which the SPS server can receive to update its billing service data. The SPS server can also use SLP service requests of other kinds by means of which the search can be directed straight to the billing services or even to billing services of certain type using parameters (which are called tags in the SLP protocol). Having received the service request message the directory agent DA sends data only on the billing service or services the attributes of which match with the parameters (tags) attributes given in the service request. The billing servers BS1 to BS3 can also directly respond to these service requests by sending information on themselves. If the SPS does not know the allowed value ranges of the attributes, it carries out an attribute request according to the SLP protocol and receives the attributes and their ranges from the billing server. The data are received directly from the billing servers also when there is no directory agent in the network.

In the following, an electronic business transaction and a payment or billing transaction related to it will be described with reference to FIG. 3.

The client contacts the service provider's server and downloads the WWW page of the commerce site to his browser. The client browses the product catalogue on the WWW page and selects the product or products he wants into the shopping basket. Finally he fills in an order form, which also includes selection of the payment method. The client may have a number of payment to choose from, which the SPS server has retrieved earlier as was described in connection with FIG. 2. Alternatively or optionally, the client can also give the name or identity of a method of payment which is not included in the alternatives given on the order form. In step 31 of FIG. 3 the client selects a method of payment as described above. After this, the SPS server checks its database to find out whether the address data and the service attributes of the billing service or billing server supporting the selected method of payment are known (step 32). If a billing server supporting the selected method of payment is found, the address data and service attributes of the billing server are retrieved from the database (step 33). If the SPS server does not know a billing server supporting the method of payment selected by the client, the SPS server sends an SLP service request (step 34). The format of this service request can be the same as that of the service request Srvrqst which was used in connection with initialisation of the SPS server. The Srvrqst message preferably comprises more detailed parameters (tags), by means of which the search is restricted to billing service of certain kind. Such a parameter can be the name of the bank, for example. In step 35 the SPS server receives a reply message, which according to the SLP protocol, for example, is a service reply Srvrply. The reply message includes the URL address of the service and service attributes for at least one billing service which conforms to the parameters defined in the service request. It should be noted that reply messages can arrive from several directory agents or billing servers. In step 36 the SPS server selects one billing service for use in the on-going payment transaction (step 36) on the basis of the replies it has received. At the same time the SPS server can update the data of the billing servers given in the replies into its database, provided that the servers are new. The criteria of the SPS service provider can also affect the selection of the billing server, such as whether a preliminary agreement is needed, which payment protocol is used, etc.

After the billing service has been found and the address data and service attributes of the billing server have been received, the SPS server sends a service request to the selected billing server on the basis of said address data. Before this, the SPS server may (at least preliminarily) configure to the payment or billing protocol of the billing server or at least communicate with the billing server using the above-mentioned service attributes. The connection between the SPS server and the billing server is preferably established as an ssl connection to ensure security. This may be followed by final configuration of the SPS server to support the payment or billing protocol of the billing server by means of the data, files or software downloaded from its billing server (step 36). After this the SPS server can function at least as one party in a billing or payment transaction which the billing server, e.g. BS1, controls.

As was stated above, the digital payment or billing protocol or system used by the billing server is not relevant to the invention. As a result of this, the client, the SPS server and the billing server BS1 can interact to complete a payment transaction in any manner. A separate secured connection can be established between the client and the billing server BS1 as the billing server BS1 and the SPS server communicate over another secured connection. The ordering and billing program of the SPS server supplies at least the price of the service or product sold and the account to which the payment should be made to the billing server BS1. Data needed to identify the client, product information (list of ordered goods) and an invoice number are preferably also supplied. Authentication of the parties can also be carried out between the billing server BS1 and the SPS. Authentication comprises exchange of certificates issued by a reliable body and public keys of the parties. In principle, this is included in the handshaking carried out when an SSL-secured connection is established but it can also be included in the functions of an upper protocol layer.

An advantage provided by the invention is that billing functions can be outsourced from the service provider's server SPS to a separate billing server. In that case the billing server BS1 can have necessary agreements with banks, for example, and thus the billing server BS1 can function as the virtual ‘seller’ in a payment transaction in accordance with the SET protocol. The service provider, who actually sells goods or services on the server SPS, does not necessarily agreements of his own. From the point of view of the billing server BS1, the client and the bank, the payment transaction is carried out as if the product had been purchased from the billing server BS1. The billing server BS1 only makes payment to the actual service provider, e.g. to his account, as a separate function. The billing server BS1 can charge a certain percent of the total price as a commission for the service before crediting the payment to the service provider. This percent can be one of the attributes included in the service data sent by the directory server and one of the selection criteria of billing servers in the SPS server. In the following, a payment transaction applying this principle will be described.

It is assumed that e-commerce between the client and the SPS server is now in the situation where it was in step 38 of FIG. 3. The SPS server receives the SET program from the billing server BS1, which is forwarded to the client's browser e.g. by sending a document including a special MIME type, ActiveX control or Java aplet. The client's SET program generates two messages. The first message contains order information consisting of the total purchase price and the order number. The second message contains payment information consisting of the client's credit card number and bank information. The order information is encrypted using a random symmetric session key and packed into a digital envelope using the public key of the SPS server. The payment information is encrypted in the same way, except that the public key of the billing server BS1 (which functions as the ‘seller’) is used. This prevents the SPS server or the billing server BS1 from finding out the credit card number or the bank from the order information. Then the client's software calculates a common hash for the order and payment information and signs it with the client's private key. This results in a ‘double signature’, which allows the SPS server, the billing server BS1 and the bank of the billing server BS2 to verify the authenticity of both message without being able to read the part intended for the other parties. The SPS server decrypts a received digital envelope with its own private key and the transfer information with the above-mentioned random symmetric session key. The SPS server adds its account and bank information to the order information and encrypts the order information with another random symmetric session key which is used between the SPS server and the server BS1 and packs the information into a digital envelope using the public key of the billing server BS1. After this, the SPS server forwards the order information and the client's payment information to the billing server BS1. The SET software of the billing server BS1 generates an authorization request, which transmits the client's payment information to the SET server (e.g. billing server BS2) of the bank of the billing server BS1. The billing server BS1 signs the authorization request with its private key to prove its identity to the bank. This request is encrypted with a new random session key and inserted into a digital envelope using the bank's public key.

The bank, i.e. billing server BS2, decrypts the seller's authorization request and verifies the seller's identity. After this, the server has to obtain authorization from the client's bank, e.g. from the billing server BS3. The BS2 generates an authorization request of its own, signs it and forwards to the bank that has issued the credit card (server BS3). The BS3 verifies the identity of the server BS3, decrypts the information and checks the client's account. If the account is in order, the server BS3 accepts the authorization request by signing it and returning it to the server BS2. The server BS2 authorizes the transaction, signs it and sends the affirmative reply back to the server BS1. The BS1 completes the transaction. The BS1 acknowledges to the client that the card has been accepted by showing an acceptance page to the client. Then the BS1 sends a message to the server BS2 which confirms the purchase and causes debiting of the client's credit card account and crediting of the account of the server BS1.

After this the billing server BS1 calculates the sum that is to be credited to the actual service provider after the billing fee has been deducted. Then the BS1 contacts the server BS2 of its bank e.g. over an SSL-secured connection and performs bank giro from its own account to the service provider's account. After this, the billing server BS1 sends confirmation to the service provider's server SPS that the payment transaction has been completed successfully. The SPS server feeds the clients order into an order processing system and delivers the goods to the client or supplies the requested service. The client can download the desired files or programs from the server SPS to the client device.

In the second example the billing server BS1 functions as a proxy server, which maintains billing data resulting from supply of chargeable services and transmits these data to the billing server (e.g. server BS2) of the telecommunications operator used by the client for billing in the client's phone bill. After a connection has been established between the service provider's server SPS and the billing server BS1 as shown in FIG. 3, the SPS server sends the client's IP address (or another identifier which the telecommunications operator can use for identifying the client) and the service provider's account data to the billing server BS1. The billing server BS1 can use the client's address to find out to which Internet subnetwork the client is connected. When the billing server BS1 finds this out, it checks its own database to find out via which telecommunications operator this client is connected to the network. By means of this information the BS1 contacts the billing server BS2 of the telecommunications operator and negotiates with the billing server BS2 about whether billing can be included in the phone bill. If this can be done, the billing server BS1 checks that the client is aware that the service is chargeable and is willing to pay for it. Acknowledgement can be performed e.g. by a combination of the public key and the private key, in which case there is no doubt about the client's identity. Having received an acknowledgement of this, the billing server BS1 informs the service provider's server SPS that the service can be supplied. After the server SPS has supplied the service or product in question to the client, it sends an acknowledgement to the billing server BS1, which initiates signalling needed for billing to the server SPS and the billing server BS2 of the telecommunications operator. The billing server BS2 of the telecommunications operator collects the client's service fees and bills the client for them together with other telecommunications payments in the phone bill.

FIGS. 4 and 5 illustrate an embodiment where the service provider's server SPS creates or downloads a file used for outsourcing of billing, such as an invoice form, on the basis of the billing service attributes sent by the directory agent.

The billing server BS1 updates its information to the directory agent (step 41) and the DA sends information on the billing services in a DAAdvert message as was described in connection with the preceding embodiments. In the SPS server the commerce site comprises normal WWW pages 51, which comprise links 52 to chargeable downloadable files or stream services (e.g. real time video). These files can be downloaded or the services initiated after billing has been carried out according to the principles of the invention. Naturally the service on sale can be any other service or product. When the client contacts the SPS server, the WWW page(s) 51 is (are) transferred to the browser of the client device (step 42). When the client wants to order a service or a product, he activates the link 52 to the service in question e.g. by clicking the mouse. As a result of link activation the client device requests (message 43) the WWW page in question from the SPS server. The requested WWW page 53 presents the methods of payment available to the user and includes a link 54 and 55 for each method of payment. The WWW page has been created on the basis of the advertising messages of the billing servers obtained from the network according to the principles described in connection with the preceding embodiments. The page information is preferably initialised when a commerce site is being established and it is updated regularly or when advertising messages are received from the network. The information on the WWW page 53 can also be updated always when the page is requested but this may cause delay in downloading of the pages. The WWW page 53 is transferred to the browser of the client device (step 44). The client selects the desired billing service and activates the corresponding link, which in the example is the link 54 of the Solo bank service. As a result of link 54 activation, the client device requests the invoice form of the selected billing service (message 45). The SPS server creates a www page which includes the structures, data and fields defined by the attributes received in the advertising message. In other words, the attribute values of each billing server contain enough information for creating an invoice form (e.g. on a blank retrieved from the network) in the format accepted by the billing server. The SPS server obtains the protocol data, URL address and attributes of the billing servers and possibly the type information of the invoice form as the value of the invoice form attribute from the advertising message DAAdvert. On the basis of the invoice form type the SPS server can download a blank invoice from the billing server, for example. Which invoice form will be used depends on the type of the invoice form supported by the billing server. Invoice forms can also be generated without a blank by using the names of the billing attributes as software references to the fields of the invoice form and any individual attribute values of each billing transaction as the values of these fields. When this arrangement is used, the SPS server can easily create an invoice form which is sent to the client as a WWW page, for example, so that the format and content of the form correspond to the requirements of the billing server.

In FIG. 5 the invoice form of the WWW page 56 includes fields 57. Before the invoice form is sent to the client device, the SPS server adds to the suitable fields of the form the reference number of the invoice, the service provider's reference number and the URL address to the directory of the SPS server to which the billing server later sends an acknowledgement of the billing carried out. Furthermore, the SPS adds a link 58 to the billing server BS1 to the form. The protocol data and URL address of the chargeable service ordered by the client are also added to the information included in the form. The billing server BS1 uses these data when it registers billing transactions and configures a WWW page which is sent to the client as an acknowledgement of billing. The WWW page must include a link which generates a request by means of which the desired service is actually transmitted to the client.

The WWW page is transferred to the client device (step 46). The client fills in the invoice form with his own data, such as his account number and name. The client can also encrypt and sign these data with his private key if the client's public key is available to the billing server. Having filled in the invoice form, the client clicks on link 58 on the form, as a result of which the invoice form is transferred to the billing server BS1 (step 47). This transfer can comprise establishment of a secured connection between the client device and the billing server BS1, or other operations. After this the billing transaction is carried out as a transaction between the client and the billing server BS1 (step 48) according to the payment protocol used.

After billing has been carried out the billing server BS1 sends an acknowledgement 49 of successful billing to the service provider's URL address, which the SPS server added to the invoice form. The acknowledgement includes the reference number of the invoice, which the SPS server also added to the invoice form. By means of this reference number the SPS server can combine an acknowledged billing transaction with the correct client, i.e. with the client's IP address. At this stage the SPS server does not necessarily have any other information on the client because the invoice form filled in by the client has not been sent to the SPS server. The SPS server saves the information on successful billing. The acknowledgement sent by the billing server BS1 may have been signed with the private key of the BS1 so that the SPS can verify the sender of the acknowledgement. The SPS and the BS1 can also communicate otherwise, depending on the payment protocol.

As an acknowledgement of billing the billing server BS1 sends (step 50) a WWW page 59 to the client, the page including a link 60 to the service the client wants. This link has been established employing the protocol information and the URL address of the chargeable service the client wants to have, which were added to the invoice form by the SPS server. The page 59 may also contain an invoice reference number.

The client clicks on link 60 on the WWW page 59 when he wants to receive the service. As a result of link 60 activation the client device sends a service request 61 to the SPS server. Having received the service request the SPS server checks using the IP address and/or the reference number that it has an acknowledgement of successful billing. If an acknowledgement is found, the SPS server carries out the service according to the service request, step 62. After the service has been completed, the SPS server stores information on this in the billing file so that later service requests with the same data can be rejected. If implementation of the service is interrupted (e.g. due to a connection failure), the billing file remains blank and the client can renew the service request.

In this embodiment of the invention no delicate information on the client, such as account numbers, are transmitted via the SPS server. Furthermore, billing has been completely outsourced, except for creation and pre-filling of the invoice form.

According to the preferred embodiments of the invention, the server can in that case transfer billing to a separate billing server which carries it out and wait for confirmation of billing carried out. The invention enables this because the server can outsource the billing transaction by means of general software which is configured according to the attributes of the billing server in the manner to be described below. The invention has been described by means of preferred embodiments. The invention is not, however, limited to these embodiments, but a person skilled in the art can implement the invention in various ways without deviating from the scope and spirit of the attached claims.

1. A method of billing services in a communications system, which comprises servers (SPS) of service providers (SPS) and billing servers (BS1-3), which provide billing services, characterized in that
address data and service attributes of billing services are transmitted in an advertising message over a data transfer network to the service provider's server (SPS),
the service provider's server (SPS) selects one billing service from among advertised billing servers (BS1-3) for the billing transaction of a client according to the parameters given by the client and said service attributes, or offers advertised billing services for the client to select,
the service provider's server (SPS) initiates the billing transaction with the billing server (BS1-3) of the selected billing service by means of said address data and service attributes.

2. A method according to claim 1, characterized in that said advertising message is sent in response to a billing service request which the service provider's server (SPS) has sent to the telecommunication network and which may include desired service attributes.

3. A method according to claim 2, characterized in that the billing service request is sent in response to billing parameters which the client gives when purchasing the service.

4. A method according to claim 1, 2 or 3, characterized in that the billing transaction is performed according to the digital payment or billing protocol supported by the selected billing server (BS1-3).

5.A method according to claim 1, 2, 3 or 4, characterized in that the billing transaction is performed after handshaking and controlled by the billing server (BS1-3) selected.

6. A method according to any one of claims 1 to 5, characterized in that the billing software of the service provider's server (SPS) is limited to software which enables tracking and selection of a suitable billing server, handshaking with the selected billing server (BS1-3) and functioning as a party in a payment or billing procedure supported by the billing server.

7. A method according to any one of claims 1 to 6, characterized in that the service provider's server (SPS) configures with the payment or billing protocol supported by the billing server (BS1-3) on the basis of said service attributes received in the advertising message and/or on the basis of the data, files or software received from the billing server after handshaking.

8. A method according to any one of claims 1 to 7, characterized in that the selected billing server (BS1-3) is responsible for verifying the client and the service provider and makes the payment to the service provider.

9. A method according to claim 8, characterized in that the billing server (BS1-3) collects the client's service payments it has made to different service providers and bills the client for them in a combined invoice at suitable intervals.

10. A method according to claim 9, characterized in that the client's service payments are billed in a service invoice of a telecommunications operator or a similar body with which the client has a service agreement.

11. A method according to claim 10, characterized in that the client's network address, telephone number or another identifier the client has received as a result of said service agreement is used as the client's identifier.

12. A communications system which comprises client devices, servers (SPS) of service providers and billing servers (BS1-3), which provide billing services, characterized in that
the billing server (BS1-3) or a separate directory server is arranged to transmit address data and service attributes of billing services to the service provider's server (SPS) in an advertising message,
the service provider's server (SPS) is arranged to select one billing service from among the advertised billing servers (BS1-3) for the billing transaction of a client according to the parameters given by the client or said service parameters or offer advertised billing services for the client to select,
the service provider's server (SPS) is arranged to initiate the billing transaction with the billing server (BS1-3) of the selected billing service by means of said address data and service attributes.

13. A system according to claim 12, characterized in that the selected billing server is responsible for verification of the client and the service provider and makes payment to the service provider.

14. A system according to claim 13, characterized in that the billing server (BS1-3) collects the client's service payments it has made to different service providers and bills the client for them in a combined invoice at suitable intervals.

15. A system according to claim 13 or 14, characterized in that the billing server (BS1-3) belongs to a telecommunications operator or a similar body with which the client has a service agreement and adds the payments made to an invoice in accordance with the service agreement.

16. A system according to claim 15, characterized in that the billing server (BS1-3) uses the client's network address, telephone number or another identifier the client has received as a result of said service agreement as the client's identifier.

17. A server of a service provider in a communications system, which comprises client devices, servers (SPS) of service providers and billing servers (BS1-3), which provide billing services, characterized in that
for the billing transactions of clients the server (SPS) uses billing services the address data and service attributes of which the server has received in advertising messages transmitted to the server,
the server (SPS) is arranged to select one billing service from among the advertised billing servers (BS1-3) for the billing transaction of a client on the basis of the parameters given by the client and said service attributes or offer advertised billing services for the client to select,
the server (SPS) is arranged to initiate a billing transaction with the billing server (BS1-3) of the selected billing service by means of said address data and service attributes.

18. A server according to claim 17, characterized in that the server (SPS) requests an advertising message by sending a billing service request which may include desired service attributes.

19. A server according to claim 17 or 18, characterized in that the server (SPS) performs the billing transaction according to the digital payment or billing protocol supported by the selected billing server and that the billing servers control this.

20. A server according to any one of claims 17 to 19, characterized in that the server's (SPS) billing software is limited to software which enables tracking and selection of a suitable billing server, handshaking with the selected billing server (BS1-3) and functioning as a party in the payment or billing procedure supported by the billing server.

21. A server according to any one of claims 17 to 21, characterized in that the server (SPS) configures with the payment or billing protocol supported by the billing server (BS1-3) on the basis of said service attributes received in the advertising message and/or on the basis of the data, file or software obtained after handshaking.

22. A method of billing services in a communications system, which comprises servers (SPS) of service providers and billing servers (BS1-3), which provide billing services, characterized in that
the address data and service attributes of the billing services are transmitted in an advertising message to the service provider's server (SPS) over a telecommunication network,
employing said address data and service attributes the service provider's server (SPS) generates an electronic invoice form which corresponds to the requirements of a billing service,
the service provider's server (SPS) adds its address and billing data and a link to the billing server (BS1-3) of said billing service to the electronic invoice form,
the service provider's server (SPS) transfers said electronic invoice form to a client device in response to a purchase transaction initiated by a client,
the client adds his billing data to said invoice form,
the invoice form filled in is transferred to the billing server indicated by said link,
the billing server (BS1-3) makes payment from the client to the service provider, possibly communicating with the client device,
the billing server (BS1-3) sends an acknowledgement of the payment made to the client and/or the service provider's server (SPS).

23. A method according to claim 22, characterized in that
said acknowledgement is sent to the client device as an electronic page which includes a link to the purchased service on the service provider's server (SPS),
the client places the actual order by activating said link to the service,
the service provider's server (SPS) checks whether an acknowledgement related to this order has been received from the billing server (BS1-3), and if this is the case, the server supplies the ordered service.

24. A method according to claim 22 or 23, characterized in that said electronic form and electronic page are implemented as World Wide Web (WWW) pages or as Wireless Application Protocol (WAP) pages.

25. A method according to claim 22, 23 or 24, characterized in that the service provider's server (SPS) downloads said electronic form from the billing server (BS1-3) by means of said address data and service attributes or generates an electronic invoice form by means of said service attributes.

26. A server of a service provider in a telecommunication system, which comprises client devices, servers (SPS) of service providers and billing servers (BS1-3), which provide billing services, characterized in that
for the billing transactions of clients the server (SPS) uses the billing services the address data and service attributes of which the server has received in advertising messages transmitted to it,
the server (SPS) is arranged to utilize said address data and service attributes to generate or download an electronic invoice form which corresponds to the requirements of a billing service and transfer said electronic invoice provided with its own billing information and a link directed to said billing service or transfer said electronic invoice provided with the address of the billing service to the client device for the client to fill in and for forwarding to said billing service.

27. A server according to claim 26, characterized in that the server (SPS) supplies the purchased service after it has received information on payment of the invoice from the billing server and/or the client device.
